(19) United States
(12) Patent Application Publication
(10) Pub. No.: US 2024/0083395 A1
(43) Pub. Date: Mar. 14, 2024

(54) FLAT TIRE BUDDY

(71) Applicant: MARTIN FLUSS, LAKE WORTH, FL (US)

(72) Inventor: MARTIN FLUSS, LAKE WORTH, FL (US)

(21) Appl. No.: 17/803,637

(22) Filed: Sep. 13, 2022

(51) Int. Cl. B60S 13/00; B62B 3/10; B62B 5/00; B62B 5/04

(52) U.S. Cl. CPC B60S 13/00; B62B 3/10; B62B 5/0083; B62B 5/04; B62B 2202/90; B62B 2203/70

(57) ABSTRACT

Flat Tire Buddy is comprised of a steel cradle provided with a pair of rear steel wheels supported on a rear axle and a central swiveling two front steel wheels. The cradle has a bottom wall and opposed spaced parallel side walls to receive a vehicle wheel therein. A pivotal rear ramp is secured to the rear axle and has a first inclined ramp section to permit the vehicle wheel to enter the cradle. The rear ramp also has a second ramp section which is actuable by the load of the vehicle wheel to cause the first plate section to pivot upward to an arresting position. The rear ramp is constructed such that when in the loading position, it causes the rear wheel to be wedged off the ground support surface. The rear ramp is provided to prevent displacement to Flat Tire Buddy when a vehicle wheel is driven in or out of the cradle over the pivotal rear ramp. At the rear of Flat Tire Buddy there are two stopper levers which stop Flat Tire Buddy from moving forward when mounting onto the cradle. In the front of Flat Tire Buddy, there are an additional two stopper levers which function in the same manner, stopping Flat Tire Buddy from moving forward when mounting with a tire onto the cradle. Dismounting with the tire from the cradle serves the same purpose for all four stopper levers for further security. All four stopper levers are disengaged before driving away with the flat tire wheel sitting in the cradle of Flat Tire Buddy. For additional safety there are straps which are tied to the tire before driving with Flat Tire Buddy.

### TECHNICAL FIELD

The present invention related to Flat Tire Buddy on which a flat tire wheel of a vehicle is positioned and supported.

### DESCRIPTION OF PREFERRED EMBODIMENTS

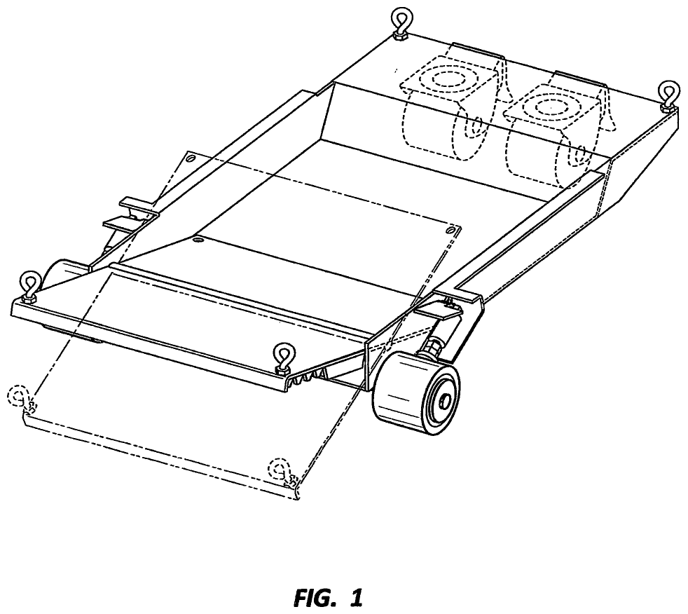

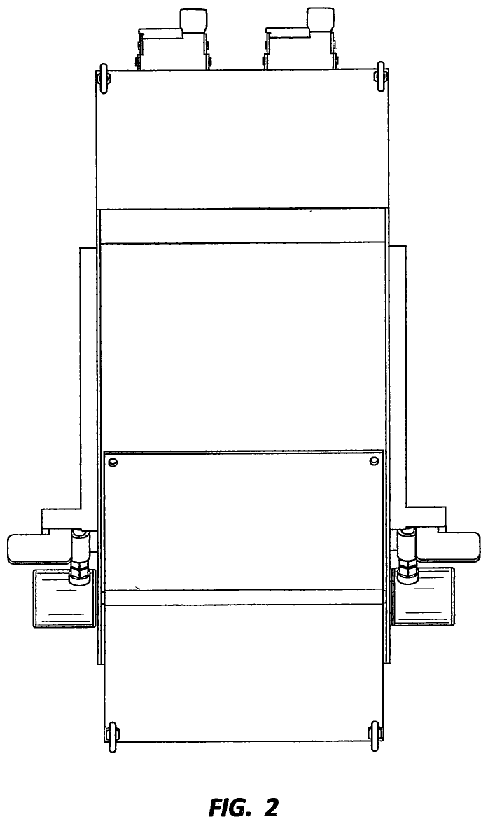

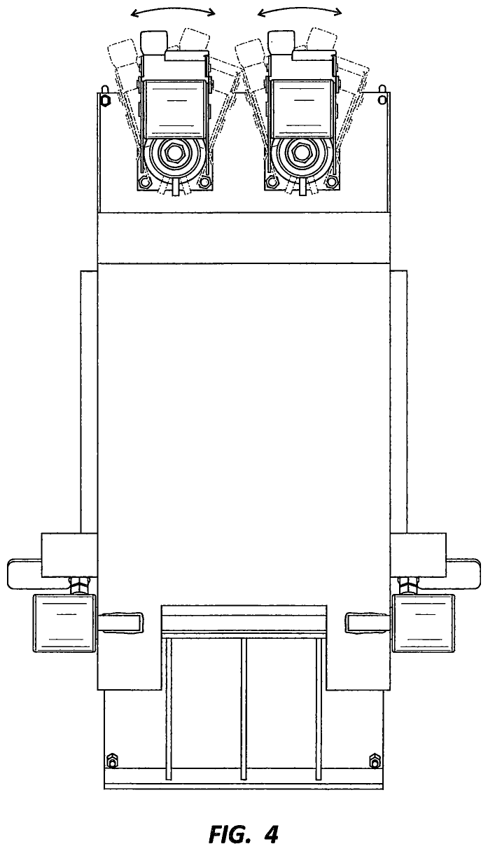

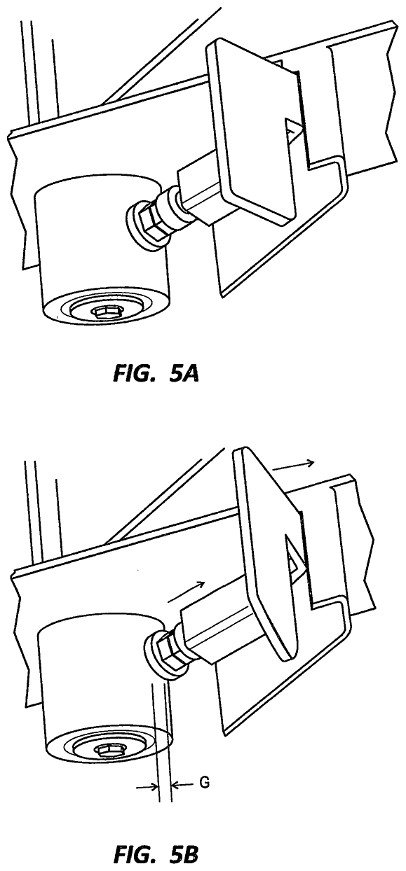

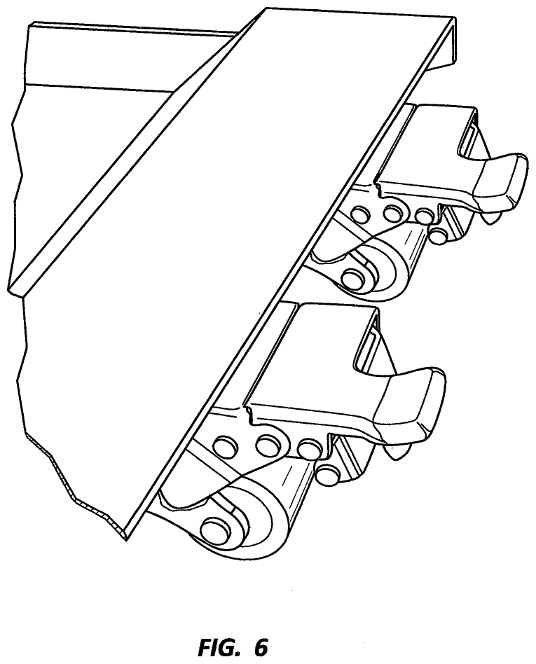

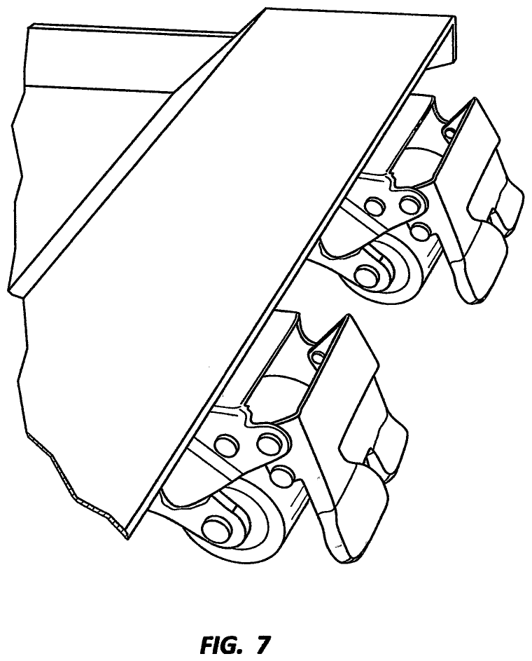

Referring now to the drawings 1 to 10, there is shown the Flat Tire Buddy of the present invention. The invention has a reinforced steel cradle and bottom steel wheel support and an open rear ramp. The two (2) rear wheels FIG. 5a, FIG. 5b, are secured at opposed ends of the rear axle and located outside the side walls of Flat Tre Buddy. The two(2) front swivel wheels are secured under a front frame to a swiveling yoke FIG. 1. and as better seen in figures FIG. 6, and FIG. 7 and both front wheels are at an angle of 45 degrees of motion which allow them to turn left, right, or driving in a forward direction. The wheels are made from steel and have been tested by a laboratory for weight capacity. Each wheel was flawless, and tested at over 20,000 pounds each for weight capacity. With total capacity is 80,000 pounds, this invention can transport any vehicle to its respective destination. (FIG. 1)

The two (2) front wheels FIG. 6, support the cradle when moving forward in order to drive the vehicle with the flat tire in the cradle, and both wheels swivel at a 45 degree angle consecutively. The stopper brake levers are in a horizontal position in order to accomplish this driving capability. FIG. 7 is just the opposite function. The two (2) stopper brake levers are in a vertical position which force this invention to remain motionless. This function avoids the invention from moving forward when loading the flat tire onto the cradle. The same applies when going in reverse to get off Flat Tire Buddy.

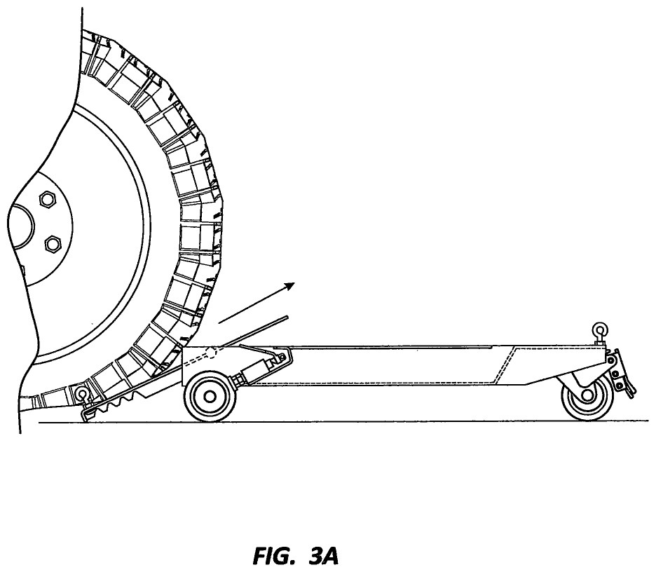

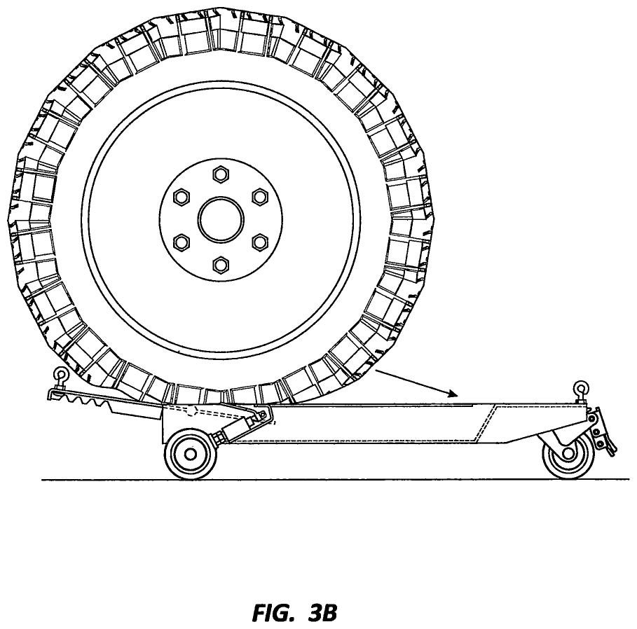

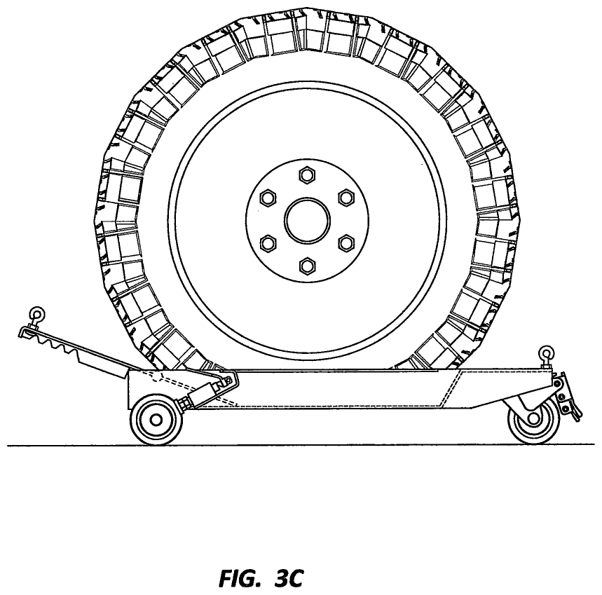

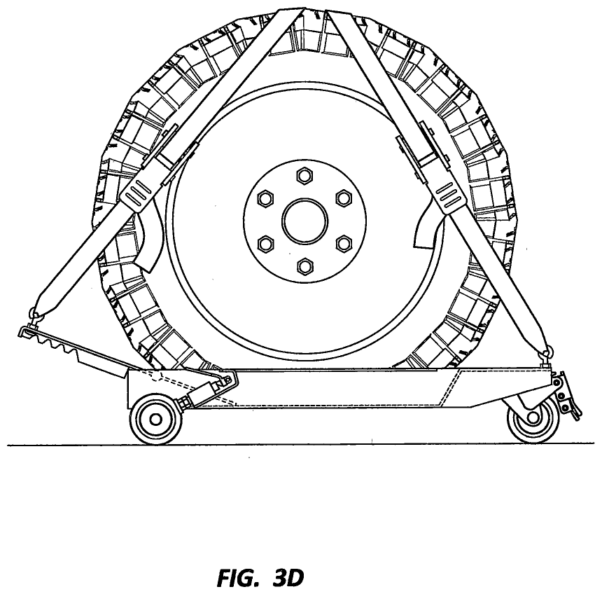

When positioned in the cradle the four (4) steel wheels function for complete safety, and are used in the same function when going forward in order to drive the vehicle, or for getting off Flat Tire Buddy. Refer to FIG. 5a, FIG. 5b, FIG. 6, FIG. 7. The stopper brake levers were incorporated to avoid injury to any motorist, and to avoid damage to the vehicle. For additional safety as an accessory added to this invention ratchet straps which tie both ends of the tire for additional safety are also included. They are not part of this invention but offered for additional safety, FIG. 3d.7

This invention is also provided with a pivotal rear ramp FIG. 3a, and is pivotally secured to the rear axle. The rear ramp has a first inclined pivotally displaceable for loading position, to an arresting position to permit a vehicle wheel to enter and become captive in the cradle, FIG. 3b, FIG. 3c. The pivotal action of the first inclined ramp is provided by an extension of this ramp by a second plate and projects inwardly and upwards of the rear axle. The second plate will hinge inwardly downward between the cradle side walls to rest on the cradle bottom wall as a vehicle wheel enters the cradle over the ramp, FIG. 3c. The second plate simultaneously causes the first inclined ramp to move upwardly and with the second plate moving downwardly. Accordingly, the first plate section is retained in its arresting position by the vehicle load against the second load.

### BACKGROUND ART

Flat tire trolleys, generally (*the type disclosed in this application, are well known in the art. As examples, thereof, reference is made to U.S. Pat. Nos. 2,608,312; 2,350,118, 3,224,611, 4,465,421,4,913,459 and 4,726,727. These patents show examples of different constructions of such trolleys. It can be observed that some of these are not provided with safety loading and arresting mechanisms and some require strenuous manual attachment between the trolley and the wheels for if not attached properly, the issue of safety becomes a very dangerous outcome for any motorist. Further, most of wheel arresting mechanisms of these trolleys are not secure and may probably disconnect during use. In addition, some of these trolleys are also not compact in structure, and are a nuisance to motorists when stored in the trunk of a vehicle. Furthermore, without the stopper wheel levers, some of these trolleys may be subjected and be projected when a flat tire vehicle wheel is being driven or unloaded from the trolley, and it would prove hazardous to the motorist and damage the vehicle. Still further, because the vehicle wheel has a portion of the vehicle load in the cradle of the trolley, it is important to have a cradle which is sturdy, and which is provided with arresting mechanisms capable of withstanding these loads, particularly if the Flat Tire Buddy is often utilized. None of the prior trolleys have the requisite structure to be usefully commercialized. In fact, they are hazardous and may cause not only damage to any motorist, but serious bodily injury, or even death.

### BACKROUND OF THE INVENTION

An apparatus for supporting the flat tire of a vehicle so that the latter can be moved without touching the ground are well known. The apparatus comprises four (4) steel wheels attached to a frame adapted to support the vehicle flat tire, and a means for mounting the vehicle tire onto the means for support. There are stopper lever brakes which are implemented and used to allow the Flat Tire Buddy to stay motionless while mounting onto the trolley, and the same applies when dismounting in reverse from Flat Tire Buddy. This a precautionary most important safety feature which protects the user from injury and potential bodily harm, as well the avoidance of structural damage to the vehicle. The two(2) steel wheels in the rear of the trolley simply rotate while driving, and the two(2) steel wheels at the front of the trolley are designed each with a stopper lever brake, which is released manually before driving on the trolley, and are so positioned that the can turn on a 45 degree angle, to allow the motorist to drive in a forward position, or turn right, or turn left while driving. There are pins which are part of the apparatus that stop the two(2) front wheels from turning on a 360 degree angle, and as a result, the apparatus functions perfectly while a flat tire sits in the cradle and is fully secure with safety in mind.

A variety of alternative frames and supports are known. In patent application U.S. Pat. No. 2,109,313, Murillo discloses a three-wheeled trolley for use for vehicles with a damaged or flat tire. This trolley has a number of disadvantages. For example, the need for a separate clamp to prevent dislodging of the tire when the trolley is driving along a bumpy road, or otherwise subjected to pressures which tend to dislodge it. Further, the trolley has very large dimensions which in addition, make it difficult to carry or to fit into the vehicle storage area.

In regards to U.S. Pat. No. 4,726,727, Tyler disclosed a six (6) wheeled trolley with a drive on ramp. Tyler's trolley has a number of disadvantages, which include the instability of the disabled tire resting on a surface that is flat, thereby not allowing the wheel to be able to withstand the forces and would definitely dislodge it while the vehicle is in motion. A further disadvantage is the bulkiness of the trolley and the closely spaced running wheels that increase with high probability that the trolley will be dislodged in the surface upon which it is driven. The large wheels on Tyler's trolley make turning of the vehicle very difficult and therefore cause instability.

In regards to U.S. Pat. No. 2,358,864, Lockwood shows a wheel trolley comprising of three(3) wheels mounted on a frame. Lockwood's trolley has several disadvantages, including the lack of a hinged frame, which causes a very large space required to be stored. His main issue is the size of his trolley.

In regards to U.S. Pat. No. 3,720,422, Nelson discloses a trolley with an adjustable frame, but without a drive-on part. A disabled tire is mounted on the trolley by first jacking up the vehicle, and then placing the trolley in such a position whereby is lowered with the flat tire onto it. The disadvantages of this apparatus are such that the driver of the vehicle is required to jack up the car in order to use the trolley. With this devise, the lateral support is minimal, which will cause the trolley to be vulnerable to an accident should the trolley hit a pot hole, and the result will be to dislodge from the flat tire, and from a sharp turn or a fast stop.

In regards to U.S. Pat. No. 3,145,860, provides an arrangement of lateral holding bars, chains. Springs and locking pins which are costly and complex.

In regards to U.S. Pat. No. 2,198,438 Knapp provides a low fixed barrier which is too high for vehicles, and incorporates rollers which force the wheel to skid and are too heavy. The need for a self-help device which makes it possible to operate a vehicle with a flat or damaged tire without the need to change that tire is self-evident. Flat tires are a common occurrence. Even under the best of circumstances, their replacement is a cumbersome and dirty job. When the flat tire must be changed under conditions of darkness, in rain or snow, or the narrow shoulder of an express highway, on sloping terrain, or under any one of a number of other adverse conditions, the job becomes extremely unpleasant and frequently even dangerous. It is also a fact that many cars driven by elderly men and women, who find the mere mechanical task of changing a flat tire beyond their capabilities. In addition, women could become vulnerable from passing motorists, especially at night with a possible danger. The need for Flat Tire Buddy is particularly critical when the tire must be replaced in the middle of a busy lane for lack of shoulders on the road or impossibility of moving the car without ruining the flat tire or the rim of the vehicle. In other instances, heavy traffic flow may be completely stalled for a long period of time, while the damaged wheel is changed, causing not only great inconvenience, but also air pollution and waist of fuel.

By using Flat Tire Buddy, the motorist will not have to deal with any of the issues indicated above, and will be able to drive on the Flat Tire Buddy to the nearest service station to repair his/her flat tire.

### SUMMARY OF INVENTION

It is therefore a feature of the present invention to provide a Flat Tire Buddy solution which substantially overcomes the above mentioned disadvantages, and offers a solution for flat or damaged tires. This invention in not only safe but a lifesaver. Many tests were conducted in regards to speed, weight capacity of its steel wheels, steel construction, its many parts, its stopper lever brakes, and for speed capacity. All tests which took many years in the making, proved to be flawless with a perfect invention for damaged or flat tires. In addition it is very storable in the trunk of any vehicle.

According to the above feature and others, and from a broad aspect, the present invention provides a trolley which comprises of a steel cradle having a bottom wheel support wall, side walls and an open rear end. A rear axle is secured across the side walls adjacent the open rear end, and elevated from the bottom support wall. Two (2) rear wheels are secured at opposed ends of the rear axle outside the side walls. Two (2) front wheels are secured under a front section of the cradle substantially thereof. The two(2) front wheels and the two(2) rear wheels support the cradle. Two front wheels abutment are secured to the cradle above the bottom support wall rearwardly of the front two (2) wheels for arresting forward movement of a vehicle wheel positioned in the cradle. A pivotal rear ramp is pivotally secured to the rear axle between the side walls. The rear ramp has a first inclined ramp section pivotally displaceable from a loading position, to permit a vehicle wheel to enter the cradle, and an arresting position, to retain a vehicle wheel in the cradle. The rear ramp has a second plate section which is secured to the first plate section and projects inwardly in the cradle and upwards of the rear axle. The second plate section causes the first plate to pivot upwardly when a load from a vehicle is driven thereon whereby the second plate section is retained in the arresting position by the vehicle wheel.

Another objective of this invention is to provide a wheel trolley that can be easily stored and carried, and which can be quickly and safely attached to a disabled tire by the user with a minimal investment of time and energy. Another objective of this invention is to provide a wheel trolley which is very easy to use, and which does not require any great degree of strength, training, or knowledge to use effectively. Another objective of this invention is to provide a wheel trolley suitable to replace the conventional spare tires used in most automobiles. In addition, car dealers no longer offer spare tires, which make this invention advantageous for any motorist. In addition, the four(4) lever brake stoppers which are part of this invention, create an environment of safety. Straps are also offered as an accessory with this invention for securing the tire, as well as a clamp for additional security while driving on the Flat Tire Buddy. Totally safe and secure for any motorist.

### REFERENCED CITED

US Patent Documents

| | | |
|---|---|---|
| 4,350,470 | September 1982 | Murillo |
| 4,726,727 | February 1988 | Tyler |
| 863122 | August 1907 | Weber |
| 3,145,860 | August 1964 | Graves |
| 3,720,422 | March 1973 | Nelson |
| 2,358,864 | July 1944 | Lockwood |
| 3,830,388 | August 1974 | Mott |
| 3,954,198 | May 1976 | Sedelmayer |

1. Flat Tire Buddy is comprised of a steel cradle having a bottom wheel support wall, side walls and an open rear end; a rear axle secured across said side walls adjacent said open rear end and elevated from said bottom support wall, two rear wheels secured at opposed ends of said rear axle outside said side walls, and two front wheels secured under a front section of said cradle substantially central thereof, said front and rear wheels supporting said cradle elevate from ground surface, front wheels abutment secured to said cradle above said bottom support wall rearwardly of said front wheels for arresting forward movement of a vehicle wheel positioned in said cradle, a pivotal rear ramp pivotally secured to said rear axle between said side walls; said rear ramp having a first inclined ramp section pivotally displaceable from a loading position to permit a vehicle wheel to enter said cradle, and an arresting position to retain a vehicle wheel in said cradle; said rear ramp having a second plate section secured to said first plate section and projecting inwardly in said cradle and upwards of said rear axle, said second plate section causing said first plate section to pivot upwardly when a vehicle wheel is driven thereon whereby said first plate section is retained in said arresting position by said vehicle wheel, said rear ramp being constructed such that when in said loading position causes said rear wheels to be wedged for ground support surface, and arresting means to prevent displacement of said Flat Tire Buddy when a vehicle wheel is driven in or out of said cradle over said pivotal ramp.

2. Flat Tire Buddy as claimed in claim 1 wherein said arresting means is comprised by an arresting element immovably secured to said rear ramp and projecting from under said pivotal rear ramp whereby to engage with a rear edge portion of said cradle when said rear ramp is disposed at said loading position with said rear wheels in a locking position with stopper levers to prevent said Flat Tire Buddy from being pushed forward when a vehicle wheel is driven up said rear ramp into said cradle.

3. Flat Tire Buddy as claimed in claim 2 wherein said arresting element is constitutes by a pair of stopper levers welded to a respective sleeve disposed about said rear axle and connected to said rear ramp.

4. Flat Tire Buddy as claimed in claim 3 said wherein said bottom support wall has a recessed rear portion which defines said rear edge extending spaced forwardly of said rear axle.

5. Flat Tire Buddy as claimed in claim 2 wherein said arresting means further comprises two rear wheels locking means to prevent clockwise rotation of said rear wheels and forward projection of said Flat Tire Buddy during unloading of a vehicle wheel from said cradle and over said rear ramp while said rear wheels are on said support surface.

6. Flat Tire Buddy as claimed in claim 5 wherein said rear wheels locking means prevents said Flat Tire Buddy from being displaced in a rearward direction, said ground support surface being a hard ground surface.

7. Flat Tire Buddy as claimed in claim 5 wherein said rear wheels locking means is constituted by secured rotation.

8. Flat Tire Buddy as claimed in claim 1 wherein said first inclined ramp section is provided with ground engagement means secured thereunder and forming a straight ground engagement surface, said straight engagement surface when lying on a ground surface being spaced from a central longitudinal axis of said rear axle a distance greater than the radius of said rear wheels.

9. Flat Tire Buddy as claimed in claim 8 wherein said ground engagement means is constituted by two or more spaced vertical steel plated secured under said first inclined ramp section, said straight ground engagement surface being formed by a straight serrated lower edge of said vertical steel plates.

10. Flat Tire Buddy as claimed in claim 1 wherein said front wheels abutment is a barrier wall projecting above an open top end of said cradle in a forward end and secured to said front section of Flat Tire Buddy.

11. Flat Tire Buddy as claimed in claim 1 wherein said two front wheels are secured to a swiveling yoke secured under the front frame section of said cradle, said swiveling yoke providing approximately 45 degrees of swiveling motion to said front wheels, so Flat Tire Buddy, can move left, right or in a straight forward direction when driving with wheel of vehicle in cradle.
